(19) United States
(12) Patent Application Publication
(10) Pub. No.: US 2008/0144903 A1
(43) Pub. Date: Jun. 19, 2008

(54) Real-time hardware accelerated contour generation based on VOI mask

(76) Inventors: Bai Wang, Palo Alto, CA (US); Hongzu Wang, Milpitas, CA (US); Dongshan Fu, Santa Clara, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/586,772

(22) Filed: Oct. 25, 2006

(51) Int. Cl. G06K 9/00

(52) U.S. Cl. 382/130

(57) ABSTRACT

A method and an apparatus for volume based contour generation have been presented. In some embodiments, the method includes receiving a volume dataset representing a volume of interest (VOI) in a three-dimensional (3D) space. The method may further include generating a contour of the VOI from the volume dataset representing the VOI, wherein at least a portion of the generating is performed using a graphics processing unit.

### TECHNICAL FIELD

The present invention relates generally to image processing. More particularly, this invention relates to volume based contour generation using a graphic processing unit.

### BACKGROUND

Contour generation has many useful applications, such as showing tumor contour on top of a three-dimensional (3D) image or a digitally reconstructed radiograph (DRR). Contour generation is also widely used by the computer game and animation film industries. Some conventional approaches to generate contour are presented below.

According to one conventional approach, two-dimensional (2D) edge detection is used to generate 2D contours of an object in some applications. Specifically, the edge detection may be implemented by contour tracking. One fundamental step of image analysis is segmentation, which partitions an image into individual objects. One existing way of segmentation is gray level edge detection. The outputs of edge detectors are usually linked together to form continuous boundaries for further processing, such as shape analysis. Hence, besides edge location, the output may also include other features, such as thinness and continuity of edge segments. According to one conventional approach, the edge direction is used to trace an edge segment. Further, different edge operators have been developed for edge detection, such as Sobel operator, a three-level template matching operator, and the Frei-Chen operator.

In addition to 2D contour generation, conventional software has been developed to render 3D contour. Currently, the discontinuities in a z-buffer derivative are highlighted to render the contour according to one conventional approach. Another current approach renders the outlines of 3D objects by applying edge detection filters to specially prepared depth and normal maps, and then compositing the results with the rest of the image showing the object. Another current approach to render contour of a 3D object is model based. Specifically, the technique uses image processing and a stochastic, physically based particle system to draw the visible contour of a 3D model of the object. To detect the contour, a depth map of the model and a few simple parameters set by a user are used.

However, one common drawback of the above conventional techniques is that they are computationally expensive. Since the above conventional techniques are implemented using complex software executed by some conventional hardware, such as general-purpose processors. Since the software is usually computationally intensive, it may take a long time to generate contours by running the software on conventional hardware, and thus, it will not be practical to apply the above conventional technique in real-time applications.

### BRIEF DESCRIPTION OF THE DRAWINGS

The present invention is illustrated by way of example and not limitation in the figures of the accompanying drawings in which like references indicate similar elements.

FIG. 1 illustrates one embodiment of a process to generate a contour.

FIG. 2 illustrates one embodiment of a volume-based contour generator.

FIG. 3A illustrates one embodiment of a digitally reconstructed radiograph (DRR) generator.

FIG. 3B illustrates one embodiment of a treatment system that may be used to perform radiation treatment in which embodiments of the present invention may be implemented.

FIG. 3C illustrates one embodiment of a radiation treatment delivery system.

FIG. 4 illustrates one embodiment of a system to generate a contour using a graphics processing unit.

FIG. 5 illustrates pseudo code representing a portion of a contour generation process according to one embodiment of the invention.

FIG. 6A illustrates an exemplary object, one embodiment of a digitized version of the object, one embodiment of a contour of the object, and one embodiment of runs of the object.

FIG. 6B illustrates one embodiment of a crack of a portion of the object in FIG. 6A.

### DETAILED DESCRIPTION

Volume based contour generation using a graphics processing unit are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to one embodiment, contour generation may start with a volume dataset representing a volume of interest (VOI) in a three-dimensional (3D) space. A contour of the VOI may be generated from the volume dataset representing the VOI, wherein at least a portion of the generation is performed using a graphics processing unit. In some embodiments, the contour is a two-dimensional (2D) contour of a projection of the VOI.

In the following discussion, a contour generally refers to an outline of an object at a particular viewpoint or viewing angle. Thus, the contour may be viewpoint dependent. A related concept is a silhouette, which typically refers to an outline of an object and a featureless interior within the outline. Thus, the contour generation techniques may be used to generate a silhouette.

The graphics processing unit described herein refers to hardware specialized in or dedicated to image processing, which is logically and/or physically separated from a general-purpose processing unit in a computing system (e.g., a central processing unit of a personal computer). For example, the graphics processing unit may include a graphics accelerator, which is a computer microelectronics component to which a computer program may offload certain image processing tasks, such as the sending and refreshing of images to the display monitor and the computation of special effects common to 2D and 3D images. Graphics accelerators may speed up the displaying of images on the monitor making it easier and faster to achieve certain graphic effects, such as, for example, the presentation of very large images and/or of interactive games in which images need to change quickly. The graphics processing unit may be implemented as hardware or a combination of hardware and software. One example of the graphics processing unit is a graphics card manufactured from a variety of vendors, such as, for example, NVIDIA Corporation® of Santa Clara, Calif. or ATI Technologies, Inc.® of Ontario, Canada, etc. To render images at real-time, the graphics processing unit may operate at a rate of at least thirty (30) frames/second in some embodiments.

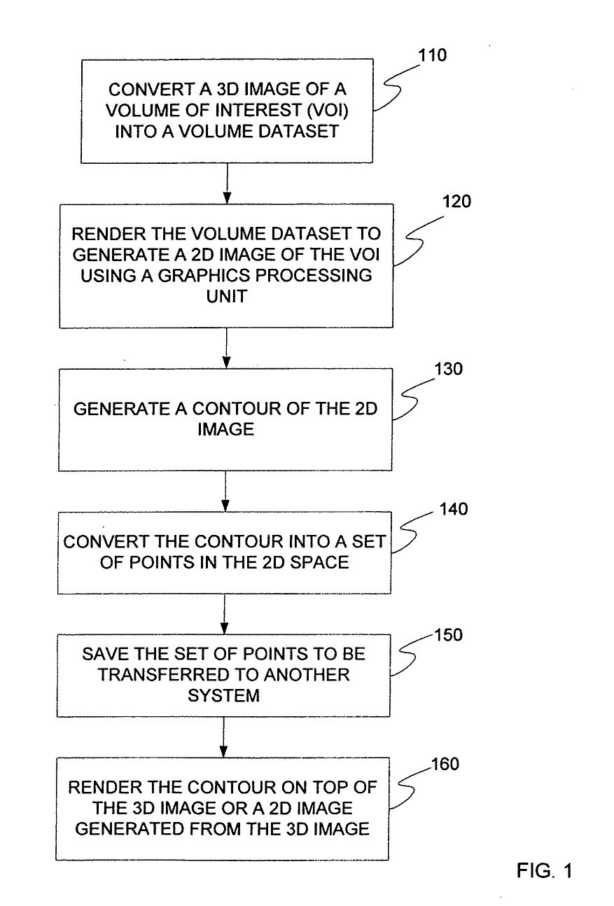

FIG. 1 illustrates one embodiment of a process to generate a contour. The process is performed by processing logic that may comprise hardware (e.g., circuitry, dedicated logic, a graphics processing unit, etc.), software (such as on a general-purpose computer system, a link device, or a dedicated machine), firmware, or a combination of any of the above.

Referring to FIG. 1, processing logic converts a three-dimensional (3D) image of a volume of interest (VOI) into a volume dataset (processing block 110). A VOI may be defined as a set of planar, closed polygons. In some embodiments, the coordinates of the polygon vertices are defined as the x/y/z offsets in a given unit from the image origin. Once a VOI has been defined, it may be represented as a bitwise mask overlaid on the functional and/or anatomical image (so that each bit is zero or one according to whether the corresponding image volume pixel (also referred to as voxel) is contained within the VOI represented by that bit), or a set of contours defining the boundary of the VOI in each image slice in a collection of imaging slices (e.g., computerized tomography (CT) slices) of the VOI. The 3D image of the VOI may be a 3D mask of the VOI. The 3D mask may be stored as a bit compressed volume, in which each byte may contain eight neighbor voxels. The volume dataset may in different formats according to different embodiments. For example, the 3D volume dataset may include an 8-bit volume dataset, a 16-bit volume dataset, a float based dataset, etc. Further, each voxel may be represented by a single byte. For binary bit based VOI mask, two-value (0 or 255) byte based data may be converted as follows: when a bit is set in bit based VOI mask, the byte of the corresponding voxel may be set to 255; if the bit is cleared, then the byte may be set to 0. Once the bit based mask has been converted to byte based data, a volume dataset is created.

In some embodiments, processing logic renders the volume dataset to generate a 2D image of the VOI using a graphics processing unit (processing block 120). Processing logic may load a direct volume rendering program into the graphics processing unit and may cause the graphics processing unit to execute the direct volume rendering program to generate the 2D image of the VOI from the volume dataset. The 2D image of the VOI may be temporarily stored in a frame buffer.

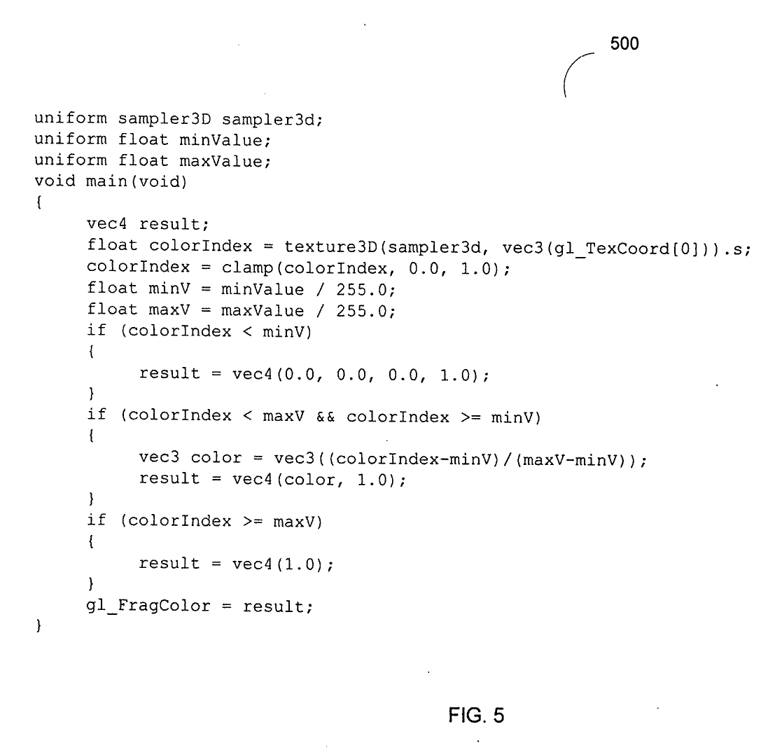

In some embodiments, processing logic then generates a contour of the 2D image in the frame buffer (processing block 130). In one embodiment, processing logic generates the contour by using a hardware accelerated fragment shader program. In one embodiment, a fragment shader program is a computer program used in 3D graphics to determine one or more surface properties of an object or an image. One embodiment of the pseudo-code of an exemplary fragment shader program is shown in FIG. 5. Alternatively, processing logic may generate the contour by executing a general-purpose processor based program.

Referring back to FIG. 1, processing logic then converts the contour into a set of points in the 2D space (processing block 140). In other words, processing logic encodes the contour in the set of points. The set of points represent the contour in the 2D space and may be further processed in another system. The set of points may be in different formats according to different contour encoding schemes, such as chain code, crack code, run code, etc. More details of contour encoding are discussed below.

In some embodiments, processing logic saves the set of points to be transferred to another system later (processing block 150). Depending on the application involved, the set of points may be transferred to different systems later, such as a radiosurgical treatment delivery system, a video game system, etc.

Finally, processing logic may render the contour on top of the 3D image or a 2D image generated from the 3D image (processing block 160). For example, the 3D image may be a CT image and the 2D image generated from the CT image may be a DRR.

Some portions of the contour generation process, such as volume rendering and fragment shader program execution, may be computationally intensive. By offloading at least part of the contour generation process to the graphics processing unit, the general-purpose processor of the computing system may be alleviated of the computationally intensive tasks. Furthermore, the graphics processing unit may be specialized in executing some predetermined graphics processes and/or the graphics processing unit may operate at a higher rate than many general-purpose processors in some embodiments. As a result, it may take less time to generate contours using the approach described herein. Because of faster speed, the contour generation approach described herein may be suitable for applications demanding high speed processing, such as real time graphics applications (e.g., lung tumor tracking in radiosurgery, video games, etc.).

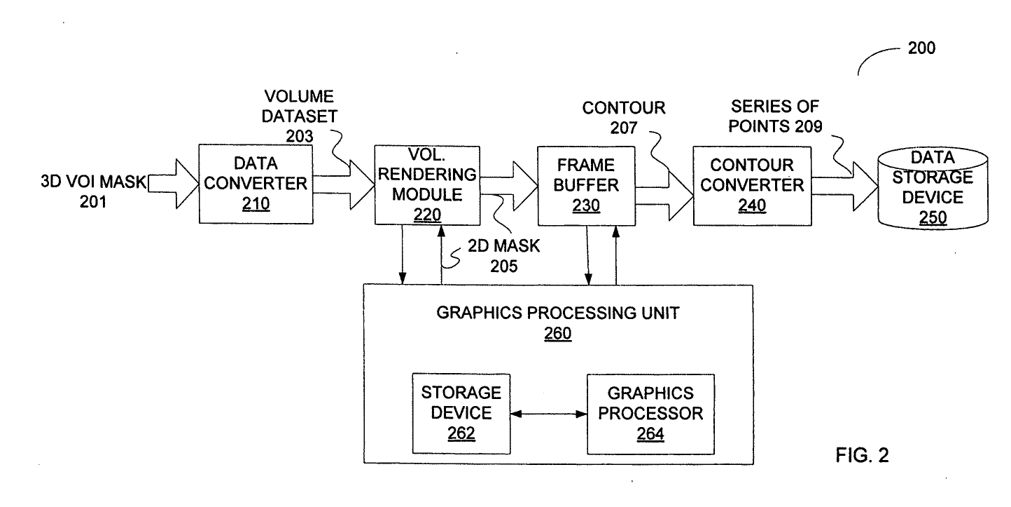

FIG. 2 illustrates one embodiment of a volume-based contour generator. The system 200 includes a data converter 210, a volume rendering module 220, a frame buffer 230, a contour converter 240, a data storage device 250, and a graphics processing unit 260. In some embodiments, the graphics processing unit 260 further includes a storage device 262 and a graphics processor 264. Note that the data converter 210 and the contour converter 240 may be implemented using software executable on a general-purpose processing unit, such as a central processing unit (CPU) of a personal computer, dedicated hardware, or a combination of both.

Referring to FIG. 2, data of a 3D VOI mask 201 is input to the data converter 210. The data converter 210 converts the data of the 3D VOI mask 201 into a volume dataset 203. The volume dataset 203 may include different types of data, such as byte based data, integer based data, or float based data. Then the volume dataset 203 is input to the volume rendering module 220.

In some embodiments, the volume rendering module 220 loads a direct volume rendering program and the volume dataset 203 into the graphics processing unit 260 and causes the graphics processing unit 260 to execute the direct volume rendering program on the volume dataset 203. The direct volume rendering program may output a 2D projection image (a.k.a. a 2D mask) 205 of the VOI. The graphics processing unit 260 may return the 2D mask 205 to the volume rendering module 220, which may forward the 2D mask 205 to the frame buffer 230.

To generate the contour of the VOI, a fragment shader program may be loaded into the graphics processing unit 260 to process the 2D mask 205. Details of some embodiments of the fragment shader program have been discussed above. In one embodiment, the fragment shader program is loaded into the storage device 262 of the graphics processing unit 260. The graphics processor 264 may retrieve instructions of the fragment shader program from the storage device 262 for execution. In response to the instructions, the graphics processor 264 may retrieve frames of the 2D mask from the frame buffer 230. By executing the fragment shader program on the frames retrieved, the graphics processor 264 may generate a contour 207 of the VOI from the frames of the 2D mask of the VOI. The graphics processor 264 may return the contour generated to the frame buffer 230.

In some embodiments, the contour converter 240 retrieves the contour 207 from the frame buffer 230 to convert the contour into a series of points 209. The series of points 209 represent the contour in a 2D space. Further, the series of points 209 may be arranged in different formats, such as crack code, chain code, run code, etc. The series of points 209 may be stored in the data storage device 250 for later use by other systems, such as a treatment delivery system in radiosurgery.

As discussed above, the contour generation technique described herein is useful in many different applications. For instance, the technique may be applied to rendering a contour of a tumor in medical imaging in order to provide a better view of the tumor during treatment delivery in radiosurgery. Alternatively, the technique may be applied to rendering shadow of an object in a display of a video game. Other exemplary applications may include industrial imaging and non-destructive testing of materials (e.g., motor blocks in the automotive industry, airframes in the aviation industry, welds in the construction industry and drill cores in the petroleum industry), seismic surveying, etc. One exemplary application in radiosurgery is described in details below for illustrative purpose. However, it should be appreciated that application of the volume based contour generation technique described herein is not limited to the following example.

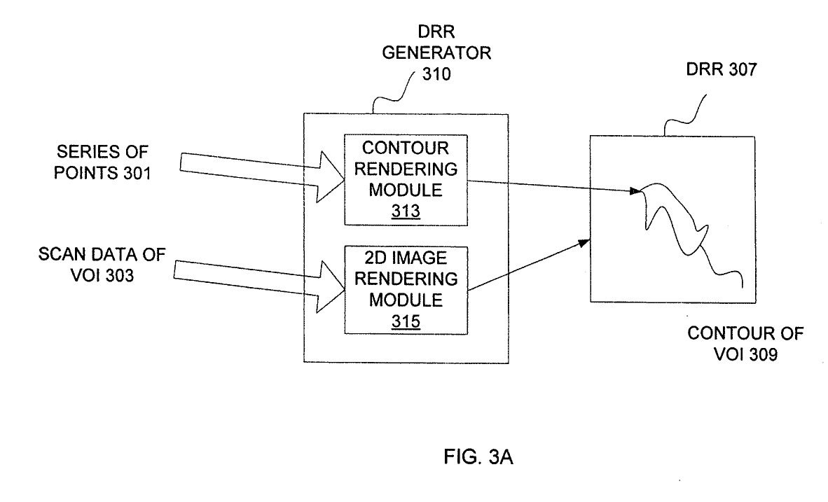

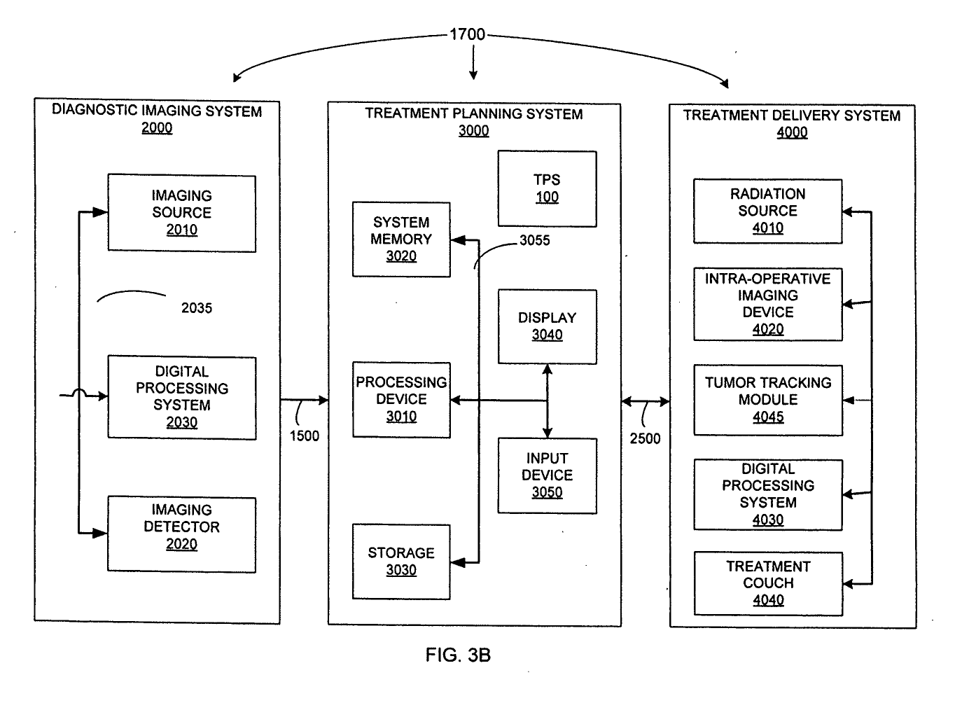

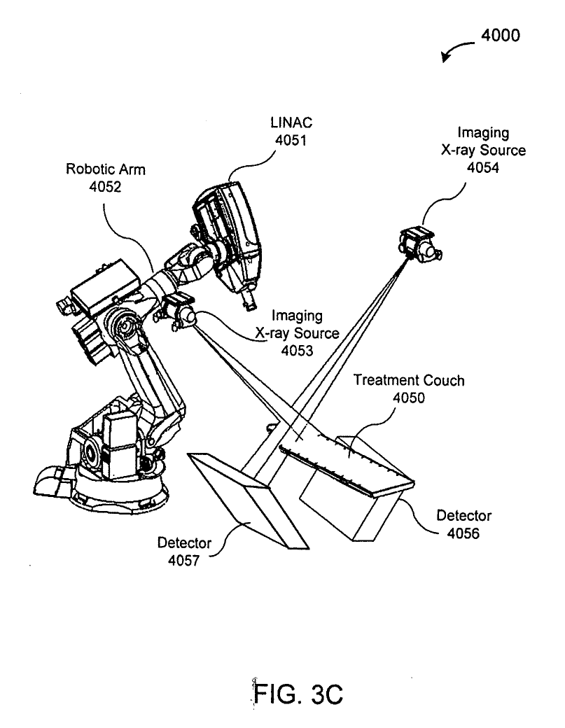

FIG. 3A illustrates one embodiment of a digitally reconstructed radiograph (DRR) generator 310, which may be used in radiosurgery to generate images of a VOI (e.g., a lung tumor, a liver tumor, a brain tumor, etc.) in a body of a patient. Referring to FIG. 3A, the DRR generator 310 includes a contour rendering module 313 and a 2D image rendering module 315. The 2D image rendering module 315 receives scan data 303 of a VOI and generates a DRR 307 containing a 2D image of the VOI based on the scan data 303. The DRR 307 is a synthetic 2D image of the VOI at a predetermined angle. The scan data 303 may include 3D scan data generated from various types of scan, such as CT scan, magnetic resonance imaging (MRI), positron emission tomography (PET) scan, ultrasound scan, etc.

In some embodiments, the contour rendering module 313 receives a series of points 301 representing a contour of the VOI. The series of points 301 have been generated using some embodiments of the contour generation described above. Based on the series of points 301, the contour rendering module 313 renders a contour 309 of the VOI over a 2D image of the VOI in the DRR 307. With the contour 309 outlining the VOI in the DRR 307, the VOI in the DRR 307 is more visible, thus, making it easier to compare the DRR 307 with other images of the VOI. As a result, tracking and locating of the VOI using the DRR 307 with the contour 309 during radiosurgery may be more accurate. Moreover, the technique described herein also improves the speed of contour generation significantly, thus, making it practical to apply some embodiments of the contour generation described herein to time sensitive applications, such as real-time tumor tracking in a treatment delivery stage of radio surgery.

FIG. 3B illustrates one embodiment of a treatment system 1700 that may be used to perform radiation treatment in which embodiments of the present invention may be implemented. The depicted treatment system 1700 includes a diagnostic imaging system 2000, a treatment planning system 3000, and a treatment delivery system 4000.

Diagnostic imaging system 2000 is representative of a system capable of producing medical diagnostic images of a VOI that may be used for subsequent diagnosis, treatment planning, and/or treatment delivery. For example, diagnostic imaging system 2000 may be a computed tomography (CT) system, a magnetic resonance imaging (MRI) system, a positron emission tomography (PET) system, an ultrasound system, or the like. For ease of discussion, diagnostic imaging system 2000 is discussed at times in relation to a CT x-ray imaging modality. However, other imaging modalities such as those above may also be used.

Diagnostic imaging system 2000 includes an imaging source 2010 to generate an imaging beam (e.g., x-rays, ultrasonic waves, radio frequency waves, etc.) and an imaging detector 2020 to detect and receive the beam generated by imaging source 2010, or a secondary beam or emission stimulated by the beam from the imaging source (e.g., in an MRI or PET scan). In one embodiment, imaging system 2000 represents a CT scanner. In one embodiment, diagnostic imaging system 2000 may include two or more diagnostic X-ray sources and two or more corresponding imaging detectors. For example, two x-ray sources may be disposed around a patient to be imaged, fixed at an angular separation from each other (e.g., 90 degrees, 45 degrees, etc.) and aimed through the patient toward (an) imaging detector(s) which may be diametrically opposed to the x-ray sources. A single large imaging detector, or multiple imaging detectors, may also be used that would be illuminated by each x-ray imaging source. Alternatively, other numbers and configurations of imaging sources and imaging detectors may be used.

The imaging source 2010 and the imaging detector 2020 are coupled to a digital processing system 2030 to control the imaging operation and process image data. Diagnostic imaging system 2000 includes a bus or other means 2035 for transferring data and commands among digital processing system 2030, imaging source 2010 and imaging detector 2020. Digital processing system 2030 may include one or more general-purpose processors (e.g., a microprocessor), special purpose processor such as a digital signal processor (DSP) or other type of device such as a controller or field programmable gate array (FPGA). Digital processing system 2030 may also include other components (not shown) such as memory, storage devices, network adapters and the like. Digital processing system 2030 may be configured to generate scan data of digital diagnostic images in a standard format, such as the DICOM (Digital Imaging and Communications in Medicine) format, for example. In other embodiments, digital processing system 2030 may generate other standard or non-standard digital image formats. Digital processing system 2030 may transmit diagnostic image files (e.g., the aforementioned DICOM formatted files) to treatment planning system 3000 over a data link 1500, which may be, for example, a direct link, a local area network (LAN) link or a wide area network (WAN) link such as the Internet. In addition, the information transferred between systems may either be pulled or pushed across the communication medium connecting the systems, such as in a remote diagnosis or treatment planning configuration. In remote diagnosis or treatment planning, a user may utilize embodiments of the present invention to diagnose or treatment plan despite the existence of a physical separation between the system user and the patient.

Treatment planning system 3000 includes a processing device 3010 to receive and process image data such as the 4D CT data discussed above. Processing device 3010 may represent one or more general-purpose processors (e.g., a microprocessor), special purpose processor such as a digital signal processor (DSP) or other type of device such as a controller or field programmable gate array (FPGA). Processing device 3010 may be configured to execute instructions for performing the operations of the methods discussed herein that, for example, may be loaded in processing device 3010 from storage 3030 and/or system memory 3020.

Treatment planning system 3000 may also include system memory 3020 that may include a random access memory (RAM), or other dynamic storage devices, coupled to processing device 3010 by bus 3055, for storing information and instructions to be executed by processing device 3010. System memory 3020 also may be used for storing temporary variables or other intermediate information during execution of instructions by processing device 3010. System memory 3020 may also include a read only memory (ROM) and/or other static storage device coupled to bus 3055 for storing static information and instructions for processing device 3010.

Treatment planning system 3000 may also include storage device 3030, representing one or more storage devices (e.g., a magnetic disk drive or optical disk drive) coupled to bus 3055 for storing information and data, for example, the CT data discussed above. Storage device 3030 may also be used for storing instructions for performing the treatment planning methods discussed herein. In some embodiment, storage device 3030 stores instructions for DRR generation. Processing device 3010 may retrieve the instructions and may execute the instructions to implement a DRR generator. Details of some embodiments of a DRR generator have been described above. Likewise, storage device 3030 stores instructions for volume-based contour generator. In some embodiments, processing device 3010 retrieves the instructions and executes the instructions to implement a volume-based contour generator. Details of some embodiments of a volume-based contour generator have been described above.

Processing device 3010 may also be coupled to a display device 3040, such as a cathode ray tube (CRT) or liquid crystal display (LCD), for displaying information (e.g., a two-dimensional or three-dimensional representation of the VOI) to the user. An input device 3050, such as a keyboard, may be coupled to processing device 3010 for communicating information and/or command selections to processing device 3010. One or more other user input devices (e.g., a mouse, a trackball or cursor direction keys) may also be used to communicate directional information, to select commands for processing device 3010 and to control cursor movements on display 3040.

It will be appreciated that treatment planning system 3000 represents only one example of a treatment planning system, which may have many different configurations and architectures, which may include more components or fewer components than treatment planning system 3000 and which may be employed with the present invention. For example, some systems often have multiple buses, such as a peripheral bus, a dedicated cache bus, etc. The treatment planning system 3000 may also include MIRIT (Medical Image Review and Import Tool) to support DICOM import (so images can be fused and target regions delineated on different systems and then imported into the treatment planning system for planning and dose calculations), expanded image fusion capabilities that allow the user to treatment plan and view dose distributions on any one of various imaging modalities (e.g., MRI, CT, PET, etc.). Treatment planning systems are known in the art; accordingly, a more detailed discussion is not provided.

Treatment planning system 3000 may share its database (e.g., data stored in storage device 3030) with a treatment delivery system, such as treatment delivery system 4000, so that it may not be necessary to export from the treatment planning system prior to treatment delivery. Treatment planning system 3000 may be linked to treatment delivery system 4000 via a data link 2500, which may be a direct link, a LAN link or a WAN link as discussed above with respect to data link 1500. It should be noted that when data links 1500 and 2500 are implemented as LAN or WAN connections, any of diagnostic imaging system 2000, treatment planning system 3000 and/or treatment delivery system 4000 may be in decentralized locations such that the systems may be physically remote from each other. Alternatively, any of diagnostic imaging system 2000, treatment planning system 3000 and/or treatment delivery system 4000 may be integrated with each other in one or more systems.

Treatment delivery system 4000 includes a therapeutic and/or surgical radiation source 4010 to administer a prescribed radiation dose to a target volume in conformance with a treatment plan. Treatment delivery system 4000 may also include an imaging device 4020 to capture intra-treatment or intra-operative images of a patient volume (including the target volume) for registration and/or correlation with the diagnostic images described above in order to position the patient with respect to the radiation source. The intra-operative imaging device 4020 may include a pair of x-ray imaging modules. Treatment delivery system 4000 may also include a digital processing system 4030 to control radiation source 4010, intra-operative imaging device 4020, and a patient support device such as a treatment couch 4040. Digital processing system 4030 may include one or more general-purpose processors (e.g., a microprocessor), special purpose processor such as a digital signal processor (DSP) or other type of device such as a controller or field programmable gate array (FPGA). Digital processing system 4030 may also include other components (not shown) such as memory, storage devices, network adapters and the like. Digital processing system 4030 may be coupled to radiation source 4010, intra-operative imaging device 4020 and treatment couch 4040 by a bus 4045 or other type of control and communication interface.

Furthermore, treatment delivery system 4000 may include a tumor tracking module 4045. In some embodiments, the intra-operative imaging device 4020 generates intra-operative images of the VOI in the patient during treatment delivery. The intra-operative images are provided to the tumor tracking module 4045, which also receives DRRs from the treatment planning system 3000. By comparing the DRRs and the intra-operative images, the tumor tracking module 4045 determines an intra-operative location of the VOI in the patient's body. Since a contour of the VOI has been rendered on each of the DRRs as described above, the image of the VOI may be more visible on the DRRs. As a result, the intra-operative location of the VOI may be determined more readily and more accurately.

It should be noted that the described treatment system 1700 is only representative of an exemplary system. Other embodiments of the system 1700 may have many different configurations and architectures and may include fewer or more components.

In one embodiment, as illustrated in FIG. 3C, treatment delivery system 4000 may be an image-guided, robotic-based radiation treatment delivery system (e.g., for performing radiosurgery) such as the CYBERKNIFE® system developed by Accuray, Inc. of California. FIG. 3C illustrates one embodiment of an image-guided, robotic-based radiation treatment delivery system. In FIG. 3C, radiation source 4010 may be represented by a linear accelerator (LINAC) 4051 mounted on the end of a robotic arm 4052 having multiple (e.g., 5 or more) degrees of freedom in order to position the LINAC 4051 to irradiate a pathological anatomy (target region or volume) with beams delivered from many angles in an operating volume (e.g., a sphere) around the patient. Treatment may involve beam paths with a single isocenter (point of convergence), multiple isocenters, or with a non-isocentric approach (i.e., the beams need only intersect with the pathological target volume and do not necessarily converge on a single point, or isocenter, within the target region as illustrated in FIG. 9). Treatment can be delivered in either a single session (mono-fraction) or in a small number of sessions as determined during treatment planning. With treatment delivery system 4000, in one embodiment, radiation beams may be delivered according to the treatment plan without fixing the patient to a rigid, external frame to register the intra-operative position of the target volume with the position of the target volume during the pre-operative treatment planning phase.

In FIG. 3C, imaging system 4020 may be represented by X-ray sources 4053 and 4054 and X-ray image detectors (imagers) 4056 and 4057. In one embodiment, for example, two x-ray sources 4053 and 4054 may be nominally aligned to project imaging x-ray beams through a patient from two different angular positions (e.g., separated by 90 degrees, 45 degrees, etc.) and aimed through the patient on treatment couch 4050 toward respective detectors 4056 and 4057. In another embodiment, a single large imager can be used that would be illuminated by each x-ray imaging source. Alternatively, other numbers and configurations of imaging sources and imagers may be used.

Digital processing system 4030 may implement algorithms to register images obtained from imaging system 4020 with pre-operative treatment planning images in order to align the patient on the treatment couch 4050 within the treatment delivery system 4000, and to precisely position the radiation source with respect to the target volume.

The treatment couch 4050 may be coupled to another robotic arm (not illustrated) having multiple degrees of freedom. The couch arm may be vertically mounted to a column or wall, or horizontally mounted to pedestal, floor, or ceiling. Alternatively, the treatment couch 4050 may be a component of another mechanical mechanism, such as the Axum® treatment couch developed by Accuray Inc. of California, or be another type of conventional treatment table known to those of ordinary skill in the art.

Alternatively, treatment delivery system 4000 may be another type of treatment delivery system, for example, a gantry based (isocentric) intensity modulated radiotherapy (IMRT) system. In a gantry based system, a radiation source (e.g., a LINAC) is mounted on the gantry in such a way that it rotates in a plane corresponding to an axial slice of the patient. Radiation is then delivered from several positions on the circular plane of rotation. In IMRT, the shape of the radiation beam is defined by a multi-leaf collimator that allows portions of the beam to be blocked, so that the remaining beam incident on the patient has a pre-defined shape. The resulting system generates arbitrarily shaped radiation beams that intersect each other at the isocenter to deliver a dose distribution to the target region. In IMRT planning, the optimization algorithm selects subsets of the main beam and determines the amount of time that the patient should be exposed to each subset, so that the prescribed dose constraints are best met. In one particular embodiment, the gantry based system may have a gimbaled radiation source head assembly.

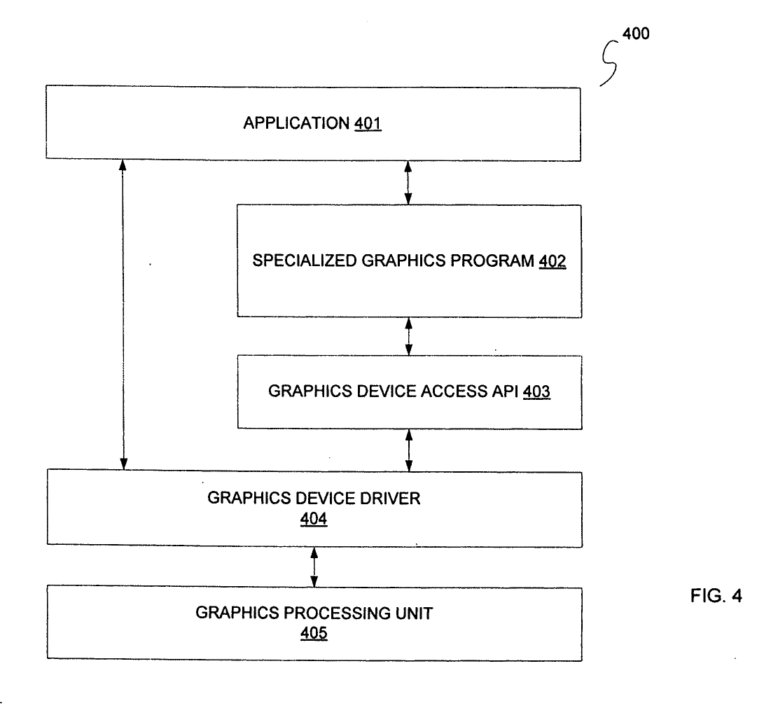

FIG. 4 illustrates the architecture of one embodiment of a system to generate a contour. The system 400 includes an application 401, a graphics device driver 404, and a graphics processing unit 405. In some embodiments, the system 400 may further include a specialized graphics program 402 and a graphics device access application program interface (API) 403. Referring to FIG. 4, the application 401 communicates with a graphics device driver 404 in order to access the graphics processing unit 405. Application 401 may include a graphical user interface (GUI) to interact with a user. For example, application 401 may be implemented as a part of CyRIS Multiplan® available from Accuray, Inc. of Sunnyvale, Calif.

In addition, specialized graphics program 402, which is a customized routine, such as, for example, a program related to DRR generation and/or a DRR enhancement routine, may be implemented to communicate with the application 401. In one embodiment, the specialized graphics program 402 may be loaded into the graphics processing unit 405, which may be implemented as part of a video adapter or a separate device, via the graphics device access API 403 and the graphics device driver 404. The graphics device access API 403 may be compatible with OpenGL® or DirectX®.

The graphics device driver 404 may be provided by a vendor of the graphics processing unit 405. Alternatively, the graphics device driver 404 may be provided by a vendor of an operating system (OS) running within the system 400. Some examples of the OS (not shown) may include a Windows® OS from Microsoft Corporation® of Washington or a Mac® OS from Apple Computer® of California. Alternatively, the OS may be UNIX, LINUX, etc.

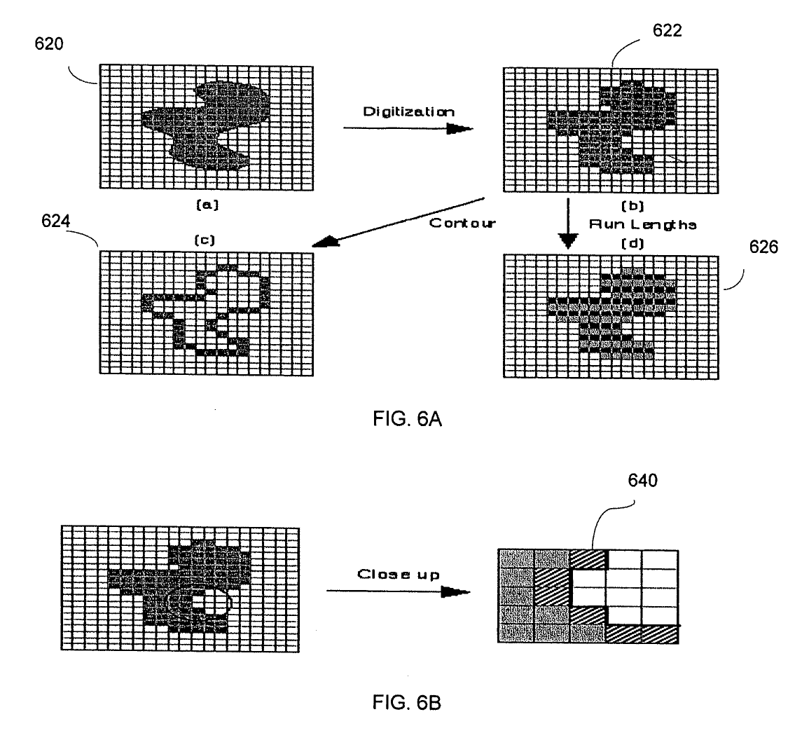

As described above, the contour generated may be represented or encoded by a series of points in the 2D space. Some exemplary formats of the encoding are discussed in details below with reference to FIGS. 6A and 6B. In the following discussion, the process begins with an image representation 620 of the object as shown in FIG. 6A. The image representation 620 may be digitized to generate a digitized representation 622 of the image in FIG. 6A.

In one embodiment, the contour is represented by chain code. The contour is traced in a clockwise manner over the digitized image 622 and the directions of the tracing are recorded as the tracing moves from one contour pixel to the next. In one embodiment, a contour pixel is an object pixel that has a non-object background pixel as one or more of its 4-connected neighbors. After tracing, a contour 624 as shown in FIG. 6A is generated.

The chain codes may be associated with eight possible directions. For instance, with x as the current contour pixel position, the chain codes are generally defined as follows:

$$Chain codes = \begin{matrix}3 & 2 & 1 \\ 4 & x & 0 \\ 5 & 6 & 7\end{matrix}$$

Even codes {0,2,4,6} correspond to horizontal and/or vertical directions, while odd codes {1,3,5,7} correspond to the diagonal directions. Each code may be considered as the angular direction, in multiples of about forty-five (45) degrees. The absolute coordinates [m,n] of the first contour pixel (e.g., top, leftmost pixel) together with the chain codes of the contour may represent a complete description of a discrete region contour. Note that a change between two consecutive chain codes may indicate that the contour has changed direction. Thus, this point is defined as a corner in some embodiments.

An alternative to the chain codes for contour representation or encoding is to use neither the contour pixels associated with the object nor the contour pixels associated with background, but rather the line, i.e., the crack, in between. This is illustrated in FIG. 6B with an enlargement 640 of a portion of the digitized image 622 in FIG. 6A. In some embodiments, the crack code is defined as:

$$Crack codes = \begin{matrix} & 1 & \\ 2 & x & 0 \\ & 3 & \end{matrix}$$

The crack code may be viewed as a chain code with four possible directions instead of eight. For example, the chain code for the enlarged section 640 in FIG. 6B, from top to bottom, is {5,6,7,7,0}, whereas the crack code is {3,2,3,3,0,3,0,0}.

Alternatively, a third representation is based on coding the consecutive pixels along a row, also referred to as a run, which belongs to an object by giving the starting position of the run and the ending position of the run. One embodiment of the runs 626 is illustrated in FIG. 6A.

Thus, some embodiments of volume based contour generation using a graphics processing unit have been described. Some portions of the preceding detailed descriptions have been presented in terms of algorithm and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a machine readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The operations and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
receiving a volume dataset representing a volume of interest (VOI) in a three-dimensional (3D) space; and
generating a two-dimensional (2D) contour of a projection of the VOI from the volume dataset representing the VOI, wherein at least a portion of the generating is performed using a graphics processing unit.

2. The method of claim 1, wherein the generating the 2D contour of the projection of the VOI comprises:
rendering the volume dataset to generate a 2D projection image of the VOI; and
generating the contour of the VOI from the 2D projection image.

3. The method of claim 2, wherein generating the 2D contour of the projection of the VOI from the 2D projection image comprises:
loading a fragment shader program into the graphics processing unit;
inputting the 2D projection image to the fragment shader program; and
executing the fragment shader program using the graphics processing unit to generate the 2D contour of the projection of the VOI.

4. The method of claim 3, wherein the graphics processing unit operates at a rate of at least 30 frames per second.

5. The method of claim 2, wherein rendering the volume dataset comprises executing a volume rendering program using the graphics processing unit.

6. The method of claim 2, further comprises:
converting a mask of the VOI in the 3D space into the volume dataset.

7. The method of claim 6, further comprising:
converting the 2D contour of the projection of the VOI into a plurality of points in a 2D space.

8. The method of claim 7, wherein the plurality of points comprise at least one of crack code, chain code, and run code.

9. The method of claim 7, further comprising:
saving the plurality of points; and
transferring the plurality of points to one or more distinct systems subsequently.

10. The method of claim 9, wherein the one or more distinct systems include a treatment delivery system of a radiosurgery system.

11. The method of claim 10, further comprising:
rendering the 2D contour of the projection of the VOI using the plurality of points over each of a plurality of 2D images of the VOI shown in a plurality of digitally reconstructed radiographs (DRRs) generated from a 3D image in which the VOI is defined.

12. The method of claim 11, wherein the 3D image is captured by at least one of computed tomography (CT) scan, magnetic resonance imaging (MRI), positron emission tomography (PET) scan, and ultrasound scan.

13. The method of claim 11, further comprising:
generating a plurality of intra-operative 2D images of the VOI during treatment delivery at the treatment delivery system; and
tracking the VOI using the plurality of DRRs and the plurality of intra-operative 2D images during treatment delivery.

14. The method of claim 13, wherein tracking the VOI using the plurality of DRRs and the plurality of intra-operative 2D images during treatment delivery comprises:
comparing the plurality of intra-operative 2D images against the plurality of DRRs with the 2D contour to determine an intra-operative location of the VOI during treatment delivery.

15. The method of claim 13, wherein the plurality of intra-operative 2D images comprise a plurality of x-ray images.

16. An apparatus comprising:
a volume rendering module to generate a two-dimensional (2D) mask of a volume of interest (VOI) from a volume dataset representing the VOI in a three-dimensional (3D) space;
a frame buffer coupled to the volume rendering module to hold one or more frames of the 2D mask; and
a graphics processing unit coupled to the frame buffer to access the one or more frames of the 2D mask and to generate a contour of the VOI from the frames of the 2D masks.

17. The apparatus of claim 16, wherein the graphics processing unit comprises:
a storage device to store one or more instructions of a fragment shader program; and
a graphics processor coupled to the storage device to retrieve and to execute the one or more instructions to generate the contour.

18. The apparatus of claim 17, wherein the graphics processor is operable to run at a rate of at least 30 frames per second.

19. The apparatus of claim 16, wherein the volume rendering module is coupled to the graphics processing unit and the volume rendering module is operable to load the volume dataset representing the VOI in the 3D space and a direct volume rendering program into the graphics processing unit and to cause the graphics processing unit to volume render the volume dataset.

20. The apparatus of claim 16, further comprising:
a data converter coupled to the volume rendering module to convert a mask of the VOI in the 3D space into the data, the data comprising a volume dataset.

21. The apparatus of claim 20, further comprising:
a contour converter coupled to the frame buffer to convert the contour into a plurality of points in a 2D space.

22. The apparatus of claim 21, wherein the plurality of points comprise at least one of crack code, chain code, and run code.

23. The apparatus of claim 21, further comprising:
a data storage device to store the plurality of points.

24. A system comprising:
a volume-based contour generator, comprising
a volume rendering module to generate a two-dimensional (2D) mask of a volume of interest (VOI) from data representing the VOI in a three-dimensional (3D) space,
a frame buffer coupled to the volume rendering module to hold frames of the 2D mask, and
a graphics processing unit coupled to the frame buffer to access the frames of the 2D masks and to generate a contour of the VOI from the frames of the 2D masks; and
a contour rendering module coupled to the volume-based contour generator to render the contour of the VOI on a 2D image of the VOI.

25. The system of claim 24, further comprising:
a 2D image generator coupled to the contour rendering module to generate the 2D image from 3D scan data of the VOI.

26. The system of claim 25, further comprising:
a radiosurgery treatment planning system comprising the volume-based contour generator, the contour rendering module, and the 2D image generator.

27. The system of claim 26, further comprising:
a radiosurgery treatment delivery system communicably coupled to the radiosurgery treatment planning system, the radiosurgery treatment delivery system comprising:
an intra-operative imaging device to generate intra-operative 2D images of the VOI; and
a tracking module coupled to the intra-operative imaging device to determine an intra-operative location of the VOI based on the intra-operative 2D images and the 2D image of the VOI with the contour of the VOI.

28. The system of claim 27, wherein the radiosurgery treatment delivery system further comprises:
a linear accelerator (LINAC) mounted to a robotic arm, to provide radiation.

29. The system of claim 27, wherein the radiosurgery treatment delivery system further comprises:
a linear accelerator (LINAC) mounted to a gantry, to provide radiation.

30. The system of claim 29, wherein the LINAC is mounted on a gimbaled head assembly.

31. The system of claim 24, wherein the graphics processing unit is loaded with a fragment shader program to generate the contour of the VOI.

32. The system of claim 31, wherein the graphics processing unit is operable at a rate of at least 30 frames per second.

33. The system of claim 24, wherein the volume rendering module is coupled to the graphics processing unit and the volume rendering module is operable to load the volume dataset representing the VOI and a direct volume rendering program into the graphics processing unit and to cause the graphics processing unit to render the volume dataset representing the VOI.

34. An apparatus comprising:
means for receiving a volume dataset representing a volume of interest (VOI) in a three-dimensional (3D) space; and
means for generating a contour of the VOI from the volume dataset representing the VOI, wherein the means for generating the contour comprises graphics hardware.

35. The apparatus of claim 34, further comprising:
means for converting the volume dataset of the VOI to a 2D mask of the VOI.

36. The apparatus of claim 34, further comprising:
means for converting the contour of the VOI into a plurality of points in a two-dimensional (2D) space.

37. The apparatus of claim 34, further comprising:
means for rendering the contour over a 2D image of the VOI.

38. A machine-readable medium that provides instructions that, if executed, will perform operations comprising:
receiving a volume dataset representing a volume of interest (VOI) in a three-dimensional (3D) space; and
generating a contour of the VOI from the volume dataset representing the VOI, wherein at least a portion of the generating is performed using a graphics processing unit.

39. The machine-readable medium of claim 38, wherein the generating the contour of the VOI comprises:
rendering the volume dataset to generate a two-dimensional (2D) mask of the VOI; and
generating the contour of the VOI from the 2D mask.

40. The machine-readable medium of claim 39, wherein generating the contour of the VOI from the 2D mask comprises:
loading a fragment shader program into the graphics processing unit;
inputting the 2D mask to the fragment shader program; and
executing the fragment shader program using the graphics processing unit to generate the contour of the VOI.

41. The machine-readable medium of claim 40, wherein the graphics processing unit operates at a rate of at least 30 frames per second.

42. The machine-readable medium of claim 39, wherein rendering the volume dataset comprises executing a volume rendering program using the graphics processing unit.

43. The machine-readable medium of claim 39, wherein the operations further comprise:
converting a mask of the VOI in the 3D space into the volume dataset.

44. The machine-readable medium of claim 43, wherein the operations further comprise:
converting the contour of the VOI into a plurality of points in a 2D space.

45. The machine-readable medium of claim 44, wherein the plurality of points comprise at least one of crack code, chain code, and run code.

46. The machine-readable medium of claim 44, wherein the operations further comprise:
saving the plurality of points; and
transferring the plurality of points to one or more distinct systems subsequently.

47. The machine-readable medium of claim 46, wherein the one or more distinct systems include a treatment delivery system of a radiosurgery system.

48. The machine-readable medium of claim 47, wherein the operations further comprise:
rendering the contour of the VOI using the plurality of points over each of a plurality of 2D images of the VOI shown in a plurality of digitally reconstructed radiographs (DRRs) generated from a 3D image of the VOI.

49. The machine-readable medium of claim 48, wherein the 3D image of the VOI is captured by at least one of computed tomography (CT) scan, magnetic resonance imaging (MRI), positron emission tomography (PET) scan, and ultrasound scan.

50. The machine-readable medium of claim 48, wherein the operations further comprise:
generating a plurality of live 2D images of the VOI during treatment delivery at the treatment delivery system; and
tracking the VOI using the plurality of DRRs and the plurality of live 2D images during treatment delivery.

51. The machine-readable medium of claim 50, wherein tracking the VOI using the plurality of DRRs and the plurality of live 2D images during treatment delivery comprises:
comparing the plurality of live 2D images against the plurality of DRRs with the contour to determine a live location of the VOI during treatment delivery.

52. The machine-readable medium of claim 50, wherein the plurality of live 2D images comprise a plurality of x-ray images.

53. A computer implemented method comprising:
converting a three-dimensional (3D) image of a volume of interest (VOI) into a volume dataset;
converting a contour of the VOI from a graphics processing unit into a plurality of points in a two-dimensional (2D) space, wherein the graphics processing unit volume renders the volume dataset to generate a 2D mask of the VOI and generates the contour of the VOI from the 2D mask of the VOI.

54. The method of claim 53, further comprising:
rendering the contour of the VOI using the plurality of points over each of a plurality of 2D images of the VOI shown in a plurality of digitally reconstructed radiographs (DRRs) generated from a 3D image of the VOI.

55. The method of claim 53, wherein the plurality of points comprise at least one of crack code, chain code, and run code.

56. The method of claim 53, further comprising:
saving the plurality of points; and
transferring the plurality of points to radiosurgical treatment delivery system subsequently.

57. The method of claim 56, further comprising:
generating a plurality of live 2D images of the VOI during treatment delivery at the treatment delivery system; and
tracking the VOI using the plurality of DRRs and the plurality of live 2D images during treatment delivery.

58. The method of claim 57, wherein tracking the VOI using the plurality of DRRs and the plurality of live 2D images during treatment delivery comprises:
comparing the plurality of live 2D images against the plurality of DRRs with the contour to determine a live location of the VOI during treatment delivery.
